(19) United States
(12) Patent Application Publication
(10) Pub. No.: US 2005/0234975 A1
(43) Pub. Date: Oct. 20, 2005

(54) Related content linking managing system, method and recording medium

(75) Inventors: Irving Fan, Shindian City (TW); Andy Chen, Shindian City (TW)

Correspondence Address: BACON & THOMAS, PLLC, 625 SLATERS LANE, FOURTH FLOOR, ALEXANDRIA, VA, 22314, US

(73) Assignee: VIA Technologies, Inc., Shindian City (TW)

(21) Appl. No.: 10/998,612

(22) Filed: Nov. 30, 2004

(30) Foreign Application Priority Data
Apr. 16, 2004 (TW) 093110776

(51) Int. Cl. G06F 17/00

(52) U.S. Cl. 707/103 R

(57) ABSTRACT

A related document content linking managing system comprises a document receiving module, a term-classification database, a classifying module, a classified document database, a document retrieving module, and an outputting module. The document receiving module is used to receive a plurality of documents. The term-classification database stores a plurality of terms and a classification of each corresponding term. According to the terms and classifications, the classifying module analyzes the documents to generate a plurality of classified documents, which are stored in the classified document database. The document retrieving module searches the classified document database to retrieve at least one of the classified documents. The outputting module outputs the retrieved document. Furthermore, a related document content linking managing method and a recording medium for recording a computer readable related document content linking managing program to execute the related document content linking managing method are provided.

### CROSS REFERENCE TO RELATED APPLICATIONS

This Non-provisional application claims priority under 35 U.S.C. §119(a) on Patent Application No. 093110776 filed in Taiwan, Republic of China on Apr. 16, 2004, the entire contents of which are hereby incorporated by reference.

### BACKGROUND OF THE INVENTION

1. Field of Invention

The invention relates to a related content managing system, and more particularly to a related document content linking managing system for managing documents.

2. Related Art

With the progress of the age, electric media have mainly become one of the document-supplying media. In general, the electric document is usually stored in an electric database, which can store a great number of electric documents. Thus, the desired electric document has to be found using the search engine in conjunction with terms for retrieving the electric documents stored in the electric database.

In the prior art of FIG. 1, for example, the user usually firstly inputs a term to the search engine (Step S01). Then, the search engine searches the electric database according to the term so as to retrieve the desired electric document (Step S02). Finally, the retrieved electric document is outputted (Step S03) by presenting the electric document for the user using a display. In step S02, the search engine usually analyzes whether or not each electric document contains a term or terms and further analyzes the message such as the appearance time and position of each term so that the relationship between the electric documents may be judged.

However, the above-mentioned retrieving method does not make the classification with respect to the content and property of each document. Thus, when the retrieving process is performed using the terms, some unrelated documents having the terms, particularly in the case when some term has various explanations, or when the algorithm of the search engine does not properly analyze the articles and generate the correct terms. For example, when the user receives the term “IDF” and hopes to search the related data of “Information Disclosure Form, IDF” stated in the U.S. Patent Law, he or she may actually find the unrelated electric document. For example, electric documents related to the “IDF” fighter, which is made in Taiwan.

In addition, the prior art still has other drawbacks. For example, when the related message is to be searched from some electric document, it is usually or necessary to retrieve all electric documents in the whole electric database, or it is only allowable to retrieve according to the existing search result. Thus, the electric documents in some specific related range cannot be retrieved in a concentrated manner. So, the efficiency of the overall search procedure is lower, and the cost thereof is higher. In addition, when a related subject is to be searched from some electric document, different terms have to be received again for retrieving. That is, no effective and convenient method is proposed to automatically start from some electric document and to search other electric documents with the related subject.

### SUMMARY OF THE INVENTION

In view of the above-mentioned problems, the invention is to provide a related document content linking managing system and a related document content linking managing method, which can effectively find the desired document out.

In addition, the invention is to provide a related document content linking managing system and a related document content linking managing method, which can retrieve the document with the specific related range.

Moreover, the invention is to provide a related document content linking managing system and a related document content linking managing method, which can conveniently find the documents with the related subject.

To achieve the above, a related document content linking managing system of the invention includes a document receiving module, a term-classification database, a classifying module, a classified document database, a document retrieving module, and an outputting module. In this aspect, the document receiving module receives a plurality of documents. The term-classification database stores a plurality of terms and at least one classification corresponding to each of the terms. The classifying module analyzes the documents according to a term extracting weight of any one of the terms in the documents and according to the at least one classification so as to generate a plurality of classified documents. The classified document database stores the classified documents. The document retrieving module searches the classified document database to retrieve at least one document. The outputting module outputs the retrieved document.

In addition, the invention also discloses a related document content linking managing method comprising the steps of: receiving a plurality of documents and creating a term-classification database for storing a plurality of terms and a classification corresponding to each term; analyzing the documents according to term extracting weights of the terms and classifications so as to generate a plurality of classified documents; searching the classified documents to retrieve at least one document; and outputting the retrieved document.

The invention further provides a recording medium, which records a computer readable related document content linking managing program. The related document content linking managing program is for the computer to perform the above-mentioned related document content linking managing method of the invention.

As mentioned hereinabove, the related document content linking managing system and method of the invention create the term-classification database in advance so as to record the classifications corresponding to each term, so it is possible to analyze the classifications corresponding to each document in advance. That is, the classified documents may be generated. Hence, the related document content linking managing system and method of the invention can effectively find the desired documents, retrieve the documents within specific related range, conveniently find the document with the related subject, and find the related subject of some document or even find the document with the corresponding subject. Thus, the efficiency of the overall search procedure may be enhanced, and the cost thereof may be correspondingly reduced.

### BRIEF DESCRIPTION OF THE DRAWINGS

The invention will become more fully understood from the detailed description given herein below illustration only, and thus is not limitative of the present invention, and wherein:

FIG. 1 is a flow chart showing a conventional related document content managing method;

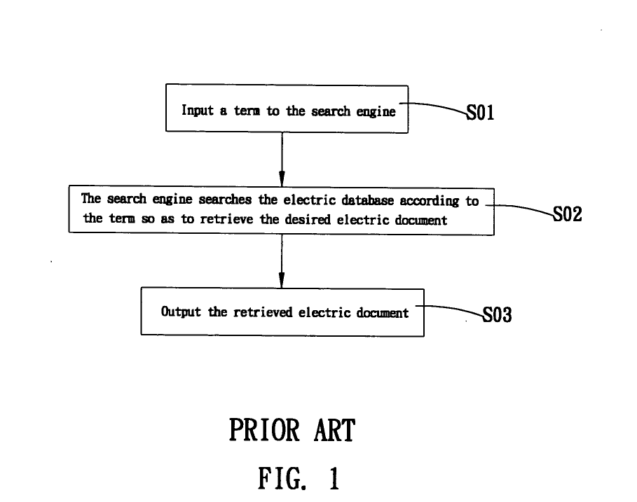

FIG. 2 is a schematic illustration showing a related document content linking managing system according to a preferred embodiment of the invention; and

FIG. 3 is a flow chart showing a related document content linking managing method according to the preferred embodiment of the invention.

### DETAILED DESCRIPTION OF THE INVENTION

The related document content linking managing system and method according to the embodiment of the invention will be described below with reference to relevant drawings, wherein the same elements are referred with the same reference numbers.

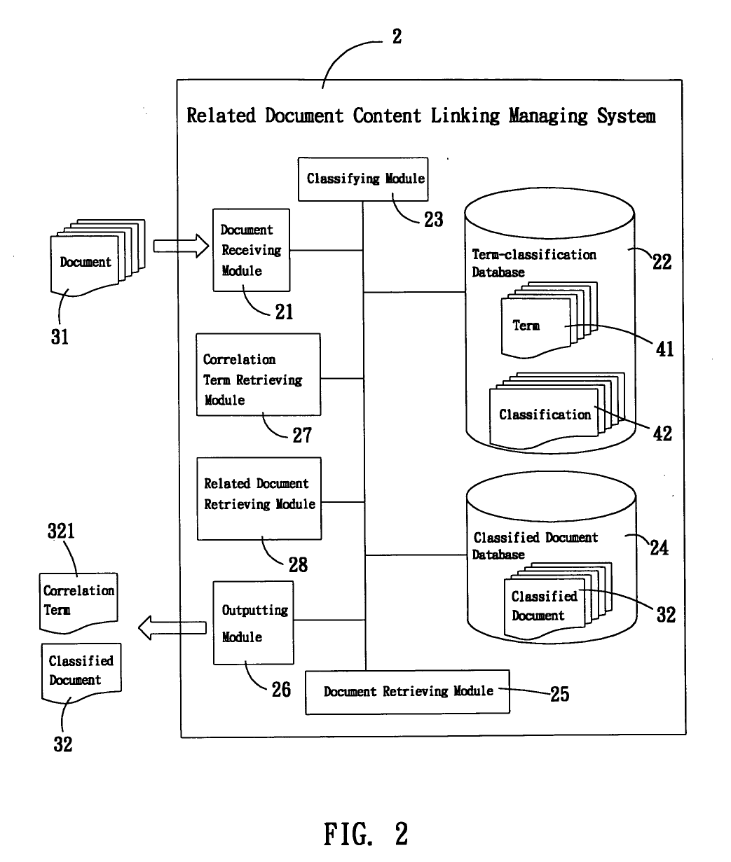

Referring to FIG. 2, a related document content linking managing system 2 according to a preferred embodiment of the invention includes a document receiving module 21, a term-classification database 22, a classifying module 23, a classified document database 24, a document retrieving module 25, and an outputting module 26. In this embodiment, the document receiving module 21 receives a plurality of documents 31. The term-classification database 22 stores a plurality of terms 41 and at least one classification 42 of each corresponding term 41. The classifying module 23 analyzes all of the documents 31 according to the term 41 (especially the term extracting weight with respect to each document 31) and the classification 42, which are recorded in the term-classification database 22, and thus generates a plurality of classified documents 32. The classified document database 24 stores the classified documents 32. The document retrieving module 25 searches the classified document database 24 (e.g., according to the search condition inputted by the user) so as to retrieve at least one document or a classified document 32. Because the document and the classified documents have a predetermined corresponding relationship, the document and the classified documents may be replaced with each other if no special limitation has been made. The outputting module 26 outputs the retrieved classified documents 32 (or document), or outputs the related document.

In this embodiment, the classifying module 23 may generate a ratio, which is a collection frequency weight of this term 41 and can represent the related degree between the term 41 and some document 31, according to the number of all documents 31 and the number of the documents 31 containing a predetermined term 41. The classifying module 23 may also obtain a terms frequency, which may represent the appearance frequency (or possible importance) of the term 41 in the document 31, according to the number of times of the term 41 appearing in the document 31. The classifying module 23 may also obtain a term extracting weight, which may represent the important degree of the term 41 in this document 31, according to a product of the collection frequency weight and the terms frequency.

Obviously, as the collection frequency weight of some term is higher, it represents that the number of documents containing the term is smaller, and is thus more unrelated to the document of some specific classification. Thus, if the collection frequency weight of some term in some document is not small, it represents that the relationship between the term and the document is high, and that other document containing this term is greatly related to this document. The collection frequency weight of the invention may have various variations, such as a value obtained by directly dividing the total number of all documents by the number of documents containing some term, taking a logarithm of this value, or taking a square root of this value. For example, the collection frequency weight may be represented by, without limitation to, the following equation:

$$\text{Collection frequency weight} = ln [ \frac{\text{Total number of all documents}}{\text{Number of documents containing some terms}} ]$$

For the sake of simplicity, the terms frequency also may be replaced by a simple scoring. For example, each of the terms related to some document may be arranged in sequence, and then the front one gets the higher weight coefficient. For instance, if some term is the first one among all the terms in the retrieved classified documents, this term is given 5 scores with respect to the related degree of the retrieved classified documents. Analogically, the second one is given 3 scores, and the third one is given 1 score. This is because the purpose of the terms frequency is to weight the weight of some term in some document. In addition, as the term extracting weight of some term is higher, it represents that the weight in some document in greater, and the appearing possibility thereof in other documents is lower. That is, the document found according to this term approximates the content to be retrieved by the user. In addition, the classifications 42 may include, without limitation to, a product classification, a technology classification, a manufacturer classification or a character classification.

In addition, the related document content linking managing system 2 may further include a correlation term retrieving module 27, which analyzes the retrieved classified documents 32 so as to retrieve at least one correlation term 321. At this time, the outputting module 26 may further output the retrieved correlation term 321. For example, the correlation term retrieving module 27 may grade the retrieved correlation terms 321, and then the outputting module 26 makes a sorting according to the level of each correlation term 321 and outputs these correlation terms 321. Also for example, the correlation term retrieving module 27 may find (or even display) other terms related to the retrieved correlation terms 321 according to the term-classification database 22, such that the user may refer to the other terms and consider, for example, whether or not a broader retrieving is to be made.

Furthermore, related document content linking managing system 2 may include a related document retrieving module 28, which analyzes the retrieved classified documents 32 so as to further retrieve other classified documents 32 related to the classified documents 32. Next, the outputting module 26 simultaneously outputs the other retrieved and associated classified documents 32. For example, when the retrieved classified documents 32 correspond to some term, the related document retrieving module 28 may find other documents corresponding to some of these terms, or find other terms related to the terms (e.g., belonging to the same or similar term classification), such that the user may consider whether or not a broader retrieving is to be made.

In this embodiment, the correlation term retrieving module 27 may also generate a ratio, which is a collection frequency weight of the retrieved correlation term 321 and capable of representing an association degree 4 between some correlation term 321 and some document 32, according to the number of all classified documents 32 and the number of the classified documents 32 containing the retrieved correlation term 321. The correlation term retrieving module 27 may also obtain a terms frequency, which may represent the appearance frequency (or possible importance) of some term 321 in the document 32 according to the number of appearance times of some correlation term 321 in some document 32. The correlation term retrieving module 27 may also obtain a term extracting weight, which may represent the important degree of some term 321 with respect to some document 32, according to a product of the collection frequency weight and the terms frequency. Herein, because the calculation details are partially the same as those of the classifying module, detailed descriptions thereof will be omitted.

It should be noted that the related document content linking managing system 2 could be implemented in an electronic apparatus. Each part of the system 2 of the invention mentioned above can be performed by hardware, software, firmware or the combinations thereof. Any skilled person can utilize the combinations of present hardware, software and/or firmware, which is still including in the spirit and scope of the invention.

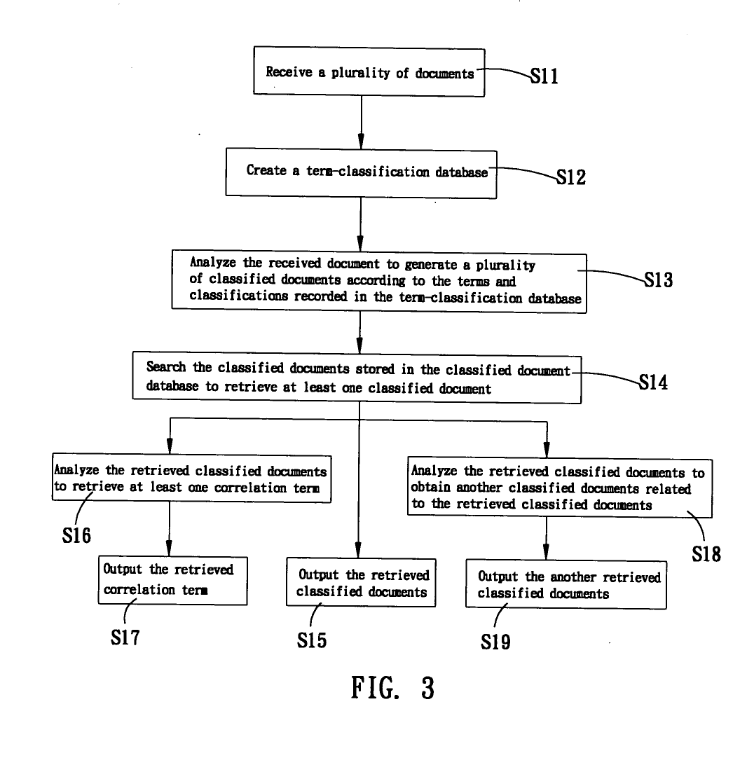

In order to make the content of the invention be easily understood, the flow of the related document content linking managing method according to the preferred embodiment of the invention will be described with reference to FIG. 3.

First, in step S11, the document receiving module receives a plurality of documents. In this embodiment, the received document is, for example, a news document, which may be the electric newspaper that may be found over Internet. At this time, the document receiving module searches from Internet and downloads the electric newspapers, the contents of which are the document of this embodiment. Of course, the user may actively input the data or the content of some electric database, and the invention is not limited thereto.

Next, in step S12, a term-classification database creating module is used to create a term-classification database and the created term-classification database stores a plurality of terms and at least one classification corresponding to each term. In this embodiment, the term may be the product title, manufacturing technology title, or human name, and the corresponding classification thereof is the product classification, technology classification, manufacturer classification, or character classification. For example, the term “VIA” belongs to the manufacturer classification, and the term “IDF” belongs to the law classification. Herein, the term database may be created actively by the user (e.g., input (key-in) each term and the grading set thereof) or created according to the data ad rules that are inputted in advance. Alternatively, the term database also may be created using the computer AI (Artificial Intelligence) function by actively analyzing each article to obtain the corresponding terms and the classifications corresponding to the terms after the user has set that various articles belong to various classifications.

It is to be emphasized that the key point of the invention is to have the term database before the step S13 is performed. Meanwhile, the step S11 may be performed before or after step S12 in the invention. The invention can start to perform step S13 as long as the documents are received and the term database does exist.

In step S13, the classifying module analyzes the received document so as to generate a plurality of classified documents according to the terms and classifications recorded in the term-classification database. In this embodiment, each classified document may contain a corresponding document and an index data, and the classified documents may be stored in one classified document database. The index data stores the classifications corresponding to each of the classified documents. Herein, each classified document may belong to one of the product classification, technology classification, manufacturer classification and character classification, and it also may belong to a plurality of classifications simultaneously. The index data also may record the corresponding term and its classification.

In step S14, the document retrieving module searches the classified documents stored in the classified document database so as to retrieve at least one classified document (or at least one document). In this embodiment, step S14 is usually performed in conjunction with a user, wherein the user may receive a term and then the classification corresponding to the term may be found from the term-classification database. Next, the classified documents belonging to this classification stored in the classified document database is searched such that the desired classified documents are retrieved and obtained. Alternatively, the user may input at least one term (or even the classification belonging to this term), and then the documents containing the term, especially the documents corresponding to a high term extracting weight (e.g., higher than a predetermined value), are found. Thus, the embodiment can retrieve the classified documents within the specific associated range and effectively search the desired document. Compared to the prior art, in which all the documents in the whole database are retrieved using the term directly, the invention can only retrieve the documents with some specific classification, or retrieve the whole database and then filter out the documents of the unwanted classification. Thus, the possibility of finding the unrelated documents owing to the term having multiple meanings may be effectively reduced. More particularly, setting and adjusting the lower bound of the term extracting weight that the retrieved document must possess (or even different terms may be respectively set and adjusted), the retrieved and obtained documents may be adjusted and changed.

Then, in step S15, the outputting module outputs the retrieved classified documents (or documents). In this embodiment, the retrieved document is displayed on an electric browser for the user in an HTTP format or a TEXT format.

In addition, the related document content linking managing method can also analyze the retrieved classified documents so as to retrieve at least one correlation term (step S16), and then the outputting module outputs the retrieved correlation term (step S17). In this embodiment, step S16 utilizes the correlation term retrieving module to analyze the retrieved classified documents so as to retrieve at least one correlation term, and step S17 sequentially outputs the correlation terms according to, for example, the high or low of the terms frequency of each of these correlation terms. Herein, the correlation term represents some term and the correlation between the term and some document is not sufficiently high (e.g., the term extracting weight is smaller than an upper bound) but is not sufficient low (e.g., the term extracting weight is larger than an upper bound). For example, when the search condition is the term “Intel”, “nanometer process” and “microprocessor principle” and when some document is “Introduction of P-IIII microprocessor”, the corresponding correlation terms may be “catch memory”, “AMD”, “computer market”.

In addition, the related document content linking managing method also can analyze the retrieved classified documents so as to obtain another classified documents related to the retrieved classified documents (step S18), and then the outputting module outputs the another retrieved classified documents (step S19). In this embodiment, step S18 utilizes the related document retrieving module to analyze the retrieved classified documents so as to further retrieve other classified documents related to the classified documents. As mentioned before, the outputting module may sequentially output the other classified documents according to the levels of the association degrees of two classified documents.

For example, it is possible to simultaneously use a first term, a second term and a third term with a term extracting weight, which is not smaller than a first threshold value, as a standard. When a document is found, at least one of the following processes is performed: (1) using the term extracting weight smaller than the first threshold value but not smaller than a second threshold value as a standard to find and display other documents; (2) using the term extracting weight not smaller than the first threshold value as a standard to find and display at least one document when only one term is used; and (3) using the term extracting weight not smaller than the first threshold value and the second threshold value as a standard to find and display at least one document when two terms are used.

The invention further provides a recording medium, such as a compact disc, a floppy disc, or a swappable hard disc drive, for recording a computer readable related document content linking managing program to execute the above-mentioned related document content linking managing method. The related document content linking managing program comprises a plurality of program segments, which correspond to the functions mentioned in the above.

In summary, the invention creates the term-classification database in advance and records the classifications corresponding to each term, so it is possible to analyze the classifications corresponding to each document in advance. That is, the classified documents may be generated. Hence, the related document content linking managing system and method of the invention can effectively find the desired documents, retrieve the documents within specific related range, and conveniently find the document with the related subject. Thus, the efficiency of the overall search procedure may be enhanced, and the cost thereof may be correspondingly reduced. More particularly, because the terms and related documents can be provided, the invention can start from some document and effectively find other terms or other documents related to the document according to the term-classification database and the classified document database. Thus, it is unnecessary to reset the search condition and search all the documents (or a portion of the previously retrieved documents).

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

1. A related document content linking managing system, comprising:
a document receiving module for receiving a plurality of documents;
a term-classification database for storing a plurality of terms and at least one classification corresponding to each of the terms;
a classifying module for analyzing the documents according to a term extracting weight of any one of the terms in the documents and according to the classification so as to generate a plurality of classified documents, wherein any one of the classified documents at least comprises a corresponding one of the documents and corresponding index data, and the index data records the classification corresponding to the corresponding one of the documents;
a classified document database for storing the classified documents; and
a document retrieving module for searching the classified document database according to at least one search condition so as to retrieve the corresponding at least one of the documents.

2. The system according to claim 1, wherein:
the classifying module obtains the term extracting weight corresponding to the term by calculating a product of a terms frequency and a collection frequency weight;
the terms frequency represents a weight of the term in the document; and
the collection frequency weight represents an association degree between the term and the document.

3. The system according to claim 2, wherein the classifying module calculates the terms frequency of the term at least according to:
the number of times of the term appeared in the document, wherein the more the number of times, the higher the terms frequency; and
an order of the term among the terms related to the document, wherein the higher the order of the term, the higher the terms frequency.

4. The system according to claim 2, wherein the classifying module calculates the collection frequency weight corresponding to the term according to the following equation:
$$\text{Collection frequency weight} = ln [ \frac{\text{Total number of all documents}}{\text{Number of documents containing some terms}} ] .$$

5. The system according to claim 1, wherein when a certain one of the documents has at least one of the terms, the classifying module assigns the specific document to at least one of the classifications corresponding to the at least one of the terms.

6. The system according to claim 1, further comprising a related document retrieving module for analyzing at least one retrieved document so as to search at least another one of the documents related to the retrieved document, wherein the documents related to the retrieved document are selected from:
the documents having the same at least one of the terms as that of the retrieved document, wherein each of the corresponding term extracting weights of the documents is smaller than a first value, which is the reference value for determining whether the document is to be searched, and larger than a second value;
the documents having the same at least one of the terms as that of the retrieved document, wherein at least one of the corresponding term extracting weights of the documents is smaller than the first value, which is the reference value for determining whether the document is to be searched, and larger than the second value; and
the documents having only a portion of at least one corresponding term of the retrieved documents.

7. The system according to claim 1, further comprising a correlation term retrieving module for analyzing at least one of the retrieved documents so as to retrieve at least one correlation term, wherein the correlation term is selected from:
the terms related to the retrieved documents and having the corresponding term extracting weight smaller than the term extracting weight of the at least one term matching a corresponding search condition; and
the terms related to the retrieved documents and having the corresponding term extracting weight smaller than a predetermined value.

8. The system according to claim 1, further comprising an outputting module, which at least:
outputs the retrieved corresponding at least one of the classified documents;
outputs a certain one of the documents and the at least one of the terms related to the certain one document; and
outputs a certain one of the documents and at least another one of the documents having the same classification.

9. A related document content linking managing method, comprising:
receiving a plurality of documents;
storing a plurality of terms and at least one classification corresponding to each of the terms;
analyzing the documents according to a term extracting weight of any one of the terms in the documents and according to the classification so as to generate a plurality of classified documents, wherein any one of the classified documents at least comprises a corresponding one of the documents and corresponding index data, and the index data records the classification corresponding to the corresponding one of the documents;
storing the classified documents; and
searching the classified documents according to at least one search condition so as to retrieve the corresponding at least one of the documents.

10. The method according to claim 9, wherein the term extracting weight corresponding to the term is obtained by calculating a product of a terms frequency and a collection frequency weight, the terms frequency represents a weight of the term in the document, and the collection frequency weight represents an association degree between the term and the document.

11. The method according to claim 10, wherein the terms frequency of the term is calculated at least according to:
the number of times of the term appeared in the document, wherein the more the number of times, the higher the terms frequency; and
an order of the term among the terms related to the document, wherein the higher the order of the term, the higher the terms frequency.

12. The method according to claim 10, wherein the collection frequency weight corresponding to the term is calculated according to the following equation:
$$\text{Collection frequency weight} = ln [ \frac{\text{Total number of all documents}}{\text{Number of documents containing some terms}} ] .$$

13. The method according to claim 9, wherein when a certain one of the documents has at least one of the terms, the specific document is assigned to at least one of the classifications corresponding to the at least one of the terms.

14. The method according to claim 9, further comprising a step of analyzing at least one retrieved document so as to search at least another one of the documents related to the retrieved document, wherein the documents related to the retrieved document are selected from:
the documents having the same at least one of the terms as that of the retrieved document, wherein each of the corresponding term extracting weights of the documents is smaller than a first value, which is the reference value for determining whether the document is to be searched, and larger than a second value;
the documents having the same at least one of the terms as that of the retrieved document, wherein at least one of the corresponding term extracting weights of the documents is smaller than the first value, which is the reference value for determining whether the document is to be searched, and larger than the second value; and
the documents having only a portion of at least one corresponding term of the retrieved documents.

15. The method according to claim 9, further comprising a step of analyzing at least one of the retrieved documents so as to retrieve at least one correlation term, wherein the correlation term is selected from:
the terms related to the retrieved documents and having the corresponding term extracting weight smaller than the term extracting weight of the at least one term matching a corresponding search condition; and
the terms related to the retrieved documents and having the corresponding term extracting weight smaller than a predetermined value.

16. The method according to claim 9, further comprising:
outputting the retrieved corresponding at least one of the classified documents;
outputting a certain one of the documents and the at least one of the terms related to the certain one document; and
outputting a certain one of the documents and at least another one of the documents having the same classification.

17. A recording medium, which records a computer readable related document content linking managing program, the program comprising:
a document receiving program segment for the computer to receive a plurality of documents;
a term-classification database establishing program segment for the computer to establish a term-classification database for storing a plurality of terms and at least one classification corresponding to each of the terms;
a classifying program segment for the computer to analyze the documents according to a term extracting weight of any one of the terms in the documents and according to the classification so as to generate a plurality of classified documents, wherein any one of the classified documents at least comprises a corresponding one of the documents and corresponding index data, and the index data records the classification corresponding to the corresponding one of the documents;
a classified document database establishing program segment for the computer to establish a classified document database for storing the classified documents; and
a document retrieving program segment for the computer to search the classified document database according to at least one search condition so as to retrieve the corresponding at least one of the documents.

18. The recording medium according to claim 17, wherein the classifying program segment further:
for the computer to obtain the term extracting weight corresponding to the term by calculating a product of a terms frequency and a collection frequency weight, wherein the terms frequency represents a weight of the term in the document, and the collection frequency weight represents an association degree between the term and the document;
for the computer to calculate the terms frequency of the term according to the number of times of the term appeared in the document, wherein the more the number of times, the higher the terms frequency;
for the computer to calculate the terms frequency of the term according to an order of the term among the terms related to the document, wherein the higher the order of the term, the higher the terms frequency;
for the computer to calculate the collection frequency weight corresponding to the term according to the following equation:
$$\text{Collection frequency weight} = ln [ \frac{\text{Total number of all documents}}{\text{Number of documents containing some terms}} ] .$$
; and
for the computer to assign the specific document, which is a certain one of the documents having at least one of the terms, to at least one of the classifications corresponding to the at least one of the terms.

19. The recording medium according to claim 17, wherein the program further comprises a related document retrieving program segment for the computer to analyze at least one retrieved document so as to search at least another one of the documents related to the retrieved document, wherein the documents related to the retrieved document are selected from:
the documents having the same at least one of the terms as that of the retrieved document, wherein each of the corresponding term extracting weights of the documents is smaller than a first value, which is the reference value for determining whether the document is to be searched, and larger than a second value;
the documents having the same at least one of the terms as that of the retrieved document, wherein at least one of the corresponding term extracting weights of the documents is smaller than the first value, which is the reference value for determining whether the document is to be searched, and larger than the second value; and
the documents having only a portion of at least one corresponding term of the retrieved documents.

20. The recording medium according to claim 17, wherein the program further comprises a correlation term retrieving program segment for the computer to analyze at least one of the retrieved documents so as to retrieve at least one correlation term, wherein the correlation term is selected from:
the terms related to the retrieved documents and having the corresponding term extracting weight smaller than the term extracting weight of the at least one term matching a corresponding search condition; and
the terms related to the retrieved documents and having the corresponding term extracting weight smaller than a predetermined value.
